(19) United States
(12) Patent Application Publication
(10) Pub. No.: US 2019/0098162 A1
(43) Pub. Date: Mar. 28, 2019

(54) CONTROLLING AN IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Koji Hosokawa, Numazu Shizuoka (JP)

(21) Appl. No.: 15/713,920

(22) Filed: Sep. 25, 2017

(51) Int. Cl. H04N 1/028; H04N 1/21; H04N 1/00

(52) U.S. Cl. CPC H04N 1/028; H04N 1/21; H04N 1/00193; H04N 1/00803; H04N 1/00148

(57) ABSTRACT

According to one embodiment, an image forming apparatus includes a sensor, an auxiliary storage device, and an operation control unit. The sensor detects disturbance. The auxiliary storage device is provided with a storage medium, and a head which performs operations of reading and writing of data with respect to the storage medium. The operation control unit does not perform a data writing operation with respect to the storage medium until a predetermined condition related to the disturbance is satisfied, and performs the data writing operation with respect to the storage medium by controlling the head, when a predetermined condition related to the disturbance is satisfied while the disturbance is detected by the sensor.

### FIELD

Embodiments described herein relate generally to an image forming apparatus, and an operation control method.

### BACKGROUND

In the related art, a technology of performing head unloading when vibration or a shock is applied to a magnetic disc which is provided in an auxiliary storage device such as a hard disk drive was known.

However, when performing unloading, there is a case in which a head and the magnetic disc come into contact with each other when moving the head to a lamp from above the magnetic disc. Accordingly, when performing unloading every time vibration or a shock is applied, there was a case in which a frequency of failure of the hard disk drive due to a contact is increased.

### BRIEF DESCRIPTION OF THE DRAWINGS

FIG. 1 is an external view which illustrates a configuration example of the entire image forming apparatus according to an embodiment.

FIG. 2 is a block diagram which illustrates a hardware configuration of the image forming apparatus.

FIG. 3 is a schematic block diagram which shows a functional configuration of a processor.

FIG. 4 is a flowchart which illustrates a flow of processing of the image forming apparatus.

FIG. 5 is a flowchart which illustrates a flow of processing of another example of the image forming apparatus.

FIG. 6 is a flowchart which illustrates a flow of processing of another example of the image forming apparatus.

FIG. 7 is a flowchart which illustrates a flow of processing of another example of the image forming apparatus.

### DETAILED DESCRIPTION

An image forming apparatus according to an embodiment includes a sensor, an auxiliary storage device, and an operation control unit. The sensor detects disturbance. The auxiliary storage device is provided with a storage medium, and a head which performs operations of reading and writing of data with respect to the storage medium. The operation control unit does not perform a data writing operation with respect to the storage medium until a predetermined condition related to the disturbance is satisfied, and performs the data writing operation with respect to the storage medium by controlling the head, when a predetermined condition related to the disturbance is satisfied, while the disturbance is detected by the sensor.

Hereinafter, an image forming apparatus in the embodiment, and an operation control method will be described with reference to drawings.

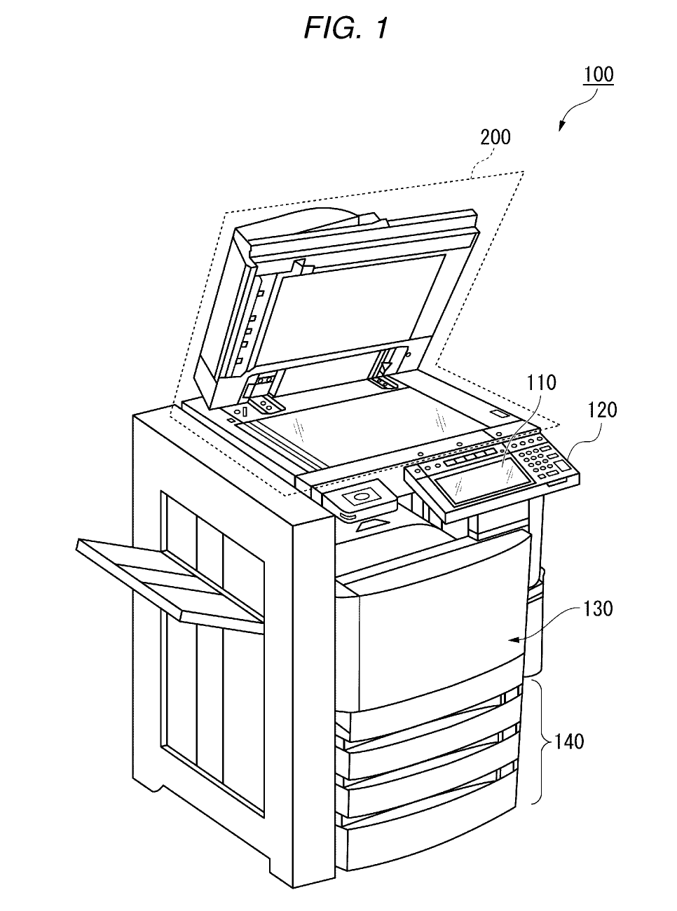

FIG. 1 is an external view which illustrates a configuration example of the entire image forming apparatus 100 according to the embodiment.

The image forming apparatus 100 according to the embodiment is a multifunction peripheral (MFP) which can form a toner image on a sheet. The sheet is, for example, the original document, or, paper, or the like, on which characters, an image, or the like, is described. The sheet may be any sheet which can be read by the image forming apparatus 100. The image forming apparatus 100 generates digital data by reading an image which is shown on the sheet, and generates an image file.

The image forming apparatus 100 is provided with a display 110, a control panel 120, a printer unit 130, a sheet accommodating unit 140, and an image reading unit 200. The printer unit 130 of the image forming apparatus 100 is a unit for fixing a toner image.

The display 110 is an image display device such as a liquid crystal display, an organic electroluminescence (EL) display, or the like. The display 110 displays various information related to the image forming apparatus 100. In addition, the display 110 outputs a signal corresponding to an operation performed by a user to a processor of the image forming apparatus 100. The display 110 receives an operation by a user.

The control panel 120 includes a plurality of buttons. The control panel 120 receives an operation by a user. The control panel 120 outputs a signal corresponding to an operation performed by a user to the processor of the image forming apparatus 100. In addition, the display 110 and the control panel 120 may be configured as an integrated touch panel.

The printer unit 130 executes image forming processing. In the image forming processing, the printer unit 130 forms an image on the sheet based on image information generated by the image reading unit 200, or image information received through a communication path.

The sheet accommodating unit 140 accommodates sheets which are used when forming an image in the printer unit 130.

The image reading unit 200 reads an image as a reading target as brightness and darkness of light. For example, the image reading unit 200 reads an image printed on the sheet as a reading target which is set on an original document reading table. The image reading unit 200 records image data which is read. The recorded image data may be transmitted to another information processing device through a network. The recorded image data may be formed on the sheet as an image using the printer unit 130.

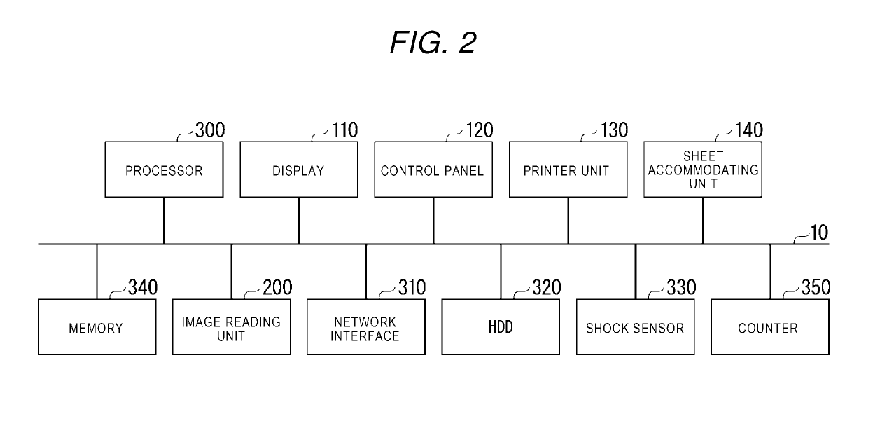

FIG. 2 is a block diagram which illustrates a hardware configuration of the image forming apparatus 100.

The image forming apparatus 100 is provided with the display 110, the control panel 120, the printer unit 130, the sheet accommodating unit 140, the image reading unit 200, a processor 300, a network interface 310, an HDD 320, a shock sensor 330, a memory 340, and a counter 350. In addition, descriptions of the display 110, the control panel 120, the printer unit 130, the sheet accommodating unit 140, the image reading unit 200 will be omitted since those are described above. Hereinafter, the processor 300, the network interface 310, the HDD 320, the shock sensor 330, the memory 340, and the counter 350 will be described. Each of the functional portions is connected through a system bus 10 so as to perform a data communication.

The processor 300 is a processor such as a central processing unit (CPU), for example. The processor 300 controls an operation of each functional portion of the image forming apparatus 100. The processor 300 executes various processing by executing a program.

The network interface 310 performs transceiving of data between the interface and another device. Here, another device is an information processing device such as a personal computer, for example. The network interface 310 is operated as an input interface, and receives data or an instruction which is transmitted from another device. The instruction transmitted from another device is an execution instruction of printing, or the like. In addition, the network interface 310 is operated as an output interface, and transmits data with respect to another device.

The HDD 320 is an auxiliary storage device which is configured by a disc which is applied with a magnetic material (hereinafter, referred to as “magnetic disc”), a head, a lamp, and a controller. The head performs an access to information stored in the magnetic disc. The lamp is a portion for retreating the head. The controller controls operations with respect to the HDD 320. For example, the controller controls the head so as to perform a reading operation of data, and a data writing operation according to an instruction (command) which is given from the processor 300. In addition, the controller performs an operation of moving the head to the lamp, for example, when there is no instruction for a predetermined period. Hereinafter, the operation of moving the head to the lamp will be described as unloading. Here, the predetermined period is several hundred milliseconds to several seconds. The HDD 320 stores various data. The various data is, for example, digital data, a job, job log, or the like. The digital data is digital data of image information generated by the image reading unit 200. The shock sensor 330 is provided at the periphery of the disc of the HDD 320. When there is an attaching adaptor, the shock sensor 330 may be provided on the attaching adaptor.

The shock sensor 330 detects disturbance such as vibration, a shock, or the like. When detecting disturbance of a predetermined threshold value, the shock sensor 330 notifies the processor 300 of detecting of the disturbance. At least a detected measured value is included in the notification output by the shock sensor 330.

The memory 340 is, for example, a random access memory (RAM). The memory 340 temporarily stores data which is used in each functional portion provided in the image forming apparatus 100. The memory 340 may store digital data generated by the image reading unit 200. The memory 340 may temporarily store a job and job log.

The counter 350 increments a counter value using a pulse signal which is output from the processor 300.

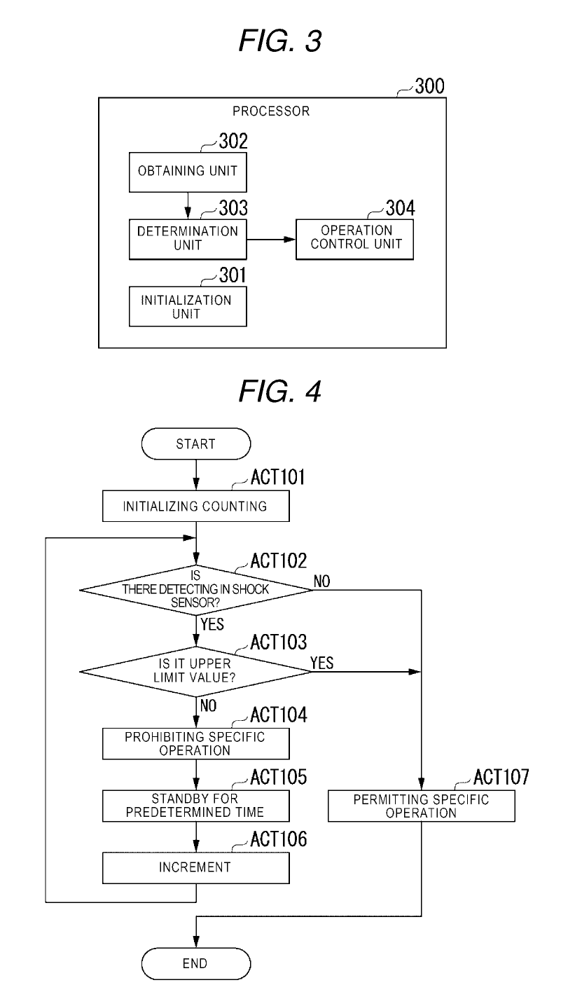

FIG. 3 is a schematic block diagram which shows a functional configuration of the processor 300. The processor 300 is provided with an initialization unit 301, an obtaining unit 302, a determination unit 303, and an operation control unit 304.

The initialization unit 301 initializes (sets counter value to zero) a counter value of the counter 350 at a predetermined timing. The predetermined timing may be a timing in which a power supply is input to the image forming apparatus 100, for example, or may be a timing in which an access to the HDD 320 is performed. The timing in which an access to the HDD 320 is performed is, for example, a timing in which reading of data from the HDD 320 is performed, or a timing in which writing of data with respect to the HDD 320 is performed.

The obtaining unit 302 obtains a notification output from the shock sensor 330.

The determination unit 303 performs determination processing. For example, the determination unit 303 determines whether or not disturbance is detected in the shock sensor 330. For example, the determination unit 303 determines whether or not the counter value in the counter 350 is an upper limit value. The upper limit value is set so as to be preset by a user.

The operation control unit 304 controls a specific operation which is related to the HDD 320, according to the determination result of the determination unit 303. The specific operation related to the HDD 320 is a data writing operation and an unloading operation with respect to the HDD 320, for example. When executing writing of data, the operation control unit 304 outputs a writing command to the controller of the HDD 320. When not causing unloading, the operation control unit 304 performs some accesses (outputting dummy reading command, or the like) so as not to put time aside for a predetermined period or more (for example, several hundred milliseconds to several seconds).

FIG. 4 is a flowchart which illustrates a flow of processing of the image forming apparatus 100. The processing in FIG. 4 is executed at a predetermined timing.

The initialization unit 301 initializes the counter value of the counter 350 (ACT 101). Subsequently, the determination unit 303 determines whether or not disturbance is detected by the shock sensor 330 (ACT 102). The determination on whether or not disturbance is detected by the shock sensor 330 is performed depending on whether or not a notification is obtained from the obtaining unit 302. When the notification is obtained from the obtaining unit 302, the determination unit 303 determines that disturbance is detected by the shock sensor. On the other hand, when the notification is not obtained from the obtaining unit 302, the determination unit 303 determines that disturbance is not detected by the shock sensor.

When disturbance is detected by the shock sensor 330 (Yes in ACT 102), the determination unit 303 determines whether or not the counter value is the upper limit value (ACT 103). The determination unit 303 determines whether or not the counter value denoted by the counter 350 is the upper limit value which is preset.

When the counter value is not the upper limit value (No in ACT 103), the determination unit 303 outputs a notification denoting that the counter value is not the upper limit value to the operation control unit 304. When obtaining the notification denoting that the counter value is not the upper limit value, the operation control unit 304 prohibits a specific operation (ACT 104). Specifically, the operation control unit 304 does not execute a data writing operation and an unloading operation with respect to the HDD 320. When the data writing operation is not executed, the operation control unit 304 does not output a writing command to the controller of the HDD 320, even when there is an instruction of data writing. In addition, when the unloading operation is not executed, the operation control unit 304 outputs a command to the controller of the HDD 320 so as not to put time aside for a predetermined period or more. For example, the operation control unit 304 outputs a dummy reading command to the controller of the HDD 320.

Thereafter, the operation control unit 304 stands by for a predetermined time (ACT 105). The predetermined time is, for example, several tens ms to several hundreds ms. In addition, the operation control unit 304 outputs a command to the controller of the HDD 320 so as not to put time aside for a predetermined period or more, also in a standby time of a predetermined time. In this manner, the operation control unit 304 performs a control so as not to cause unloading. The operation control unit 304 increments the counter value of the counter 350 after a standby of a predetermined time (ACT 106). For example, the operation control unit 304 increments the counter value by outputting a pulse of one wavelength with respect to the counter 350. The counter 350 increments the counter value by inputting a pulse of one wavelength which is output from the operation control unit 304. Thereafter, the image forming apparatus 100 executes processing in ACT 102 and thereafter.

In the processing in ACT 102, when disturbance is not detected by the shock sensor 330 (No in ACT 102), the operation control unit 304 permits a specific operation (ACT 107). Specifically, the operation control unit 304 executes any one of data writing operation and the unloading operation with respect to the HDD 320. As the data writing operation with respect to the HDD 320, the operation control unit 304 outputs a writing command to the controller of the HDD 320. The controller of the HDD 320 executes data writing with respect to the magnetic disc by controlling the head according to the writing command output from the operation control unit 304. As the unloading operation, the operation control unit 304 does not output an instruction to the controller of the HDD 320 for a predetermined period. In this manner, the controller of the HDD 320 does not obtain an instruction from the operation control unit 304 for a predetermined period. When there is no instruction from the operation control unit 304 for a predetermined period, the controller of the HDD 320 performs unloading. Thereafter, the image forming apparatus 100 ends the processing in FIG. 4.

In addition, in the processing in ACT 103, when the counter value is the upper limit value (Yes in ACT 103), the operation control unit 304 permits a specific operation (ACT 104). Thereafter, the image forming apparatus 100 ends the processing in FIG. 4.

According to the image forming apparatus 100 which is configured as described above can suppress a frequency of an occurrence of a failure of the HDD 320 due to destruction of data, destruction of the head, or the like. Specifically, the image forming apparatus 100 performs a control of prohibiting operations when disturbance is detected, or when the counter value does not reach the upper limit value. For example, the image forming apparatus 100 does not execute the data writing operation and the unloading operation. In this manner, the data writing operation and the unloading operation are not executed while disturbance is detected. Accordingly, it is possible to reduce a frequency of the data writing operation and the unloading operation while disturbance is detected. For this reason, it is possible to suppress a frequency of occurrence of a failure of the HDD 320.

In addition, the image forming apparatus 100 executes the data writing operation and the unloading operation when the counter value reaches the upper limit value. Actually, it is not preferable to keep the head on the magnetic disc while disturbance is detected, since there is a possibility that the head and the disc may come into contact with each other. In addition, regarding data writing, it is necessary to write data which is finally necessary. Accordingly, when the counter value reaches the upper limit value as described above, it is possible to perform writing of data and unloading, by performing a control of permitting operations.

Hereinafter, a modification example of the image forming apparatus 100 will be described.

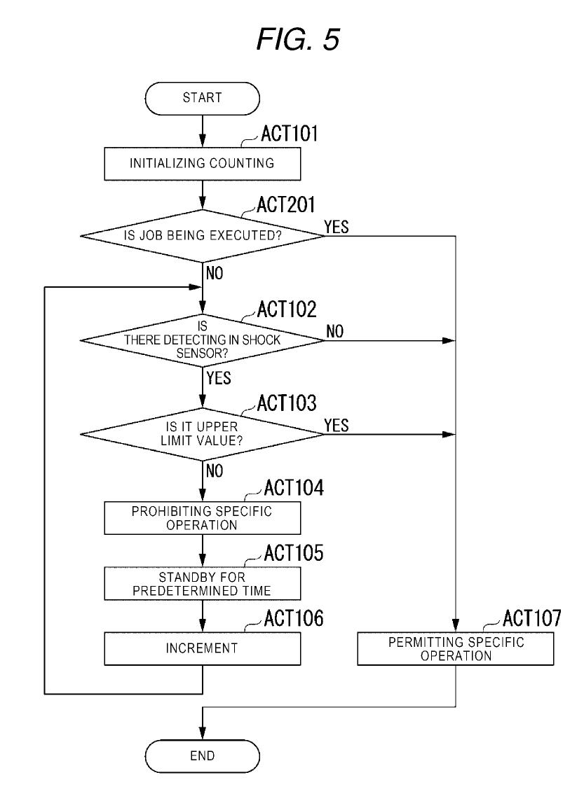

The image forming apparatus 100 may be configured so as to control permission or prohibition of a specific operation, by including the fact whether or not a job is being executed. Processing in this case will be described by using FIG. 5.

FIG. 5 is a flowchart which illustrates a flow of another example of the image forming apparatus 100. The processing in FIG. 5 is executed at a predetermined timing. In addition, the same processing as that in FIG. 4 is attached with the same reference numeral as that in FIG. 4, in FIG. 5, and descriptions thereof will be omitted.

After the processing in ACT 101, the determination unit 303 determines whether or not it is in the middle of executing a job (ACT 201). Here, the job denotes an operation instructed by a user such as copying or scanning. The determination unit 303 determines whether or not a job is being executed, based on the fact whether or not an instruction of executing a job is input at a predetermined timing. When an instruction of executing a job is input at a predetermined timing, the determination unit 303 determines that a job is being executed. In addition, when an instruction of executing a job is not input at a predetermined timing, the determination unit 303 determines that a job is not being executed. When a job is not being executed (No in ACT 201), the image forming apparatus 100 executes processing in ACT 102 and thereafter.

On the other hand, when a job is being executed (Yes in ACT 201), the image forming apparatus 100 executes processing in ACT 107.

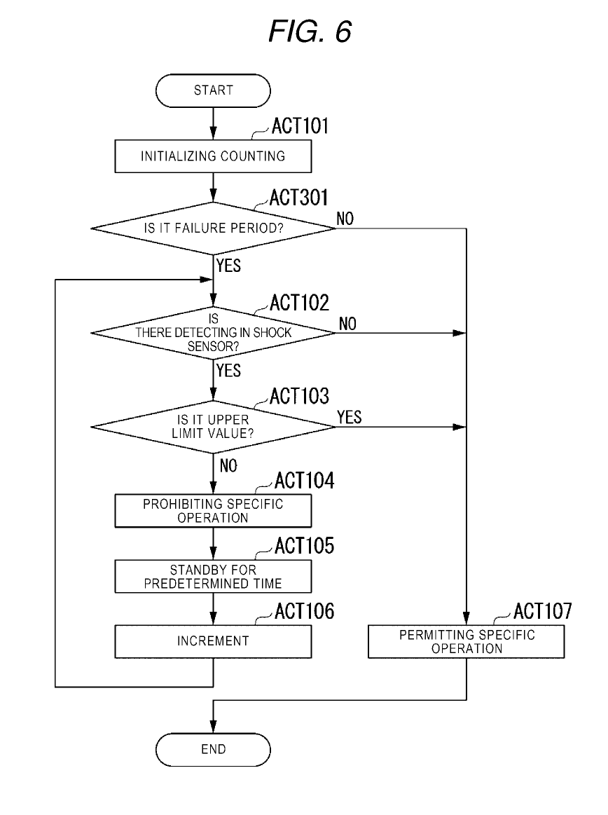

In addition, the image forming apparatus 100 may be configured so as to control permission or prohibition of a specific operation, including the fact whether or not it is a failure period. Here the failure period denotes a period from an occurrence of jam such as paper jam to resolving of jam. The failure period can be appropriately set by a user. Processing in this case will be described by using FIG. 6.

FIG. 6 is a flowchart which illustrates a flow of processing of another example of the image forming apparatus 100. The processing in FIG. 6 is executed at a predetermined timing. In addition, the same processing as that in FIG. 4 is attached with the same reference numeral as that in FIG. 4, in FIG. 6, and descriptions thereof will be omitted.

After the processing in ACT 101, the determination unit 303 determines whether or not it is a failure period (ACT 301). When jam occurs at a predetermined timing, the determination unit 303 determines that it is a failure period. In addition, when jam does not occur at a predetermined timing, the determination unit 303 determines that it is not a failure period. When it is a failure period (Yes in ACT 301), the image forming apparatus 100 executes processing in ACT 102 and thereafter.

On the other hand, when it is not a failure period (No in ACT 301), the image forming apparatus 100 executes processing in ACT 107.

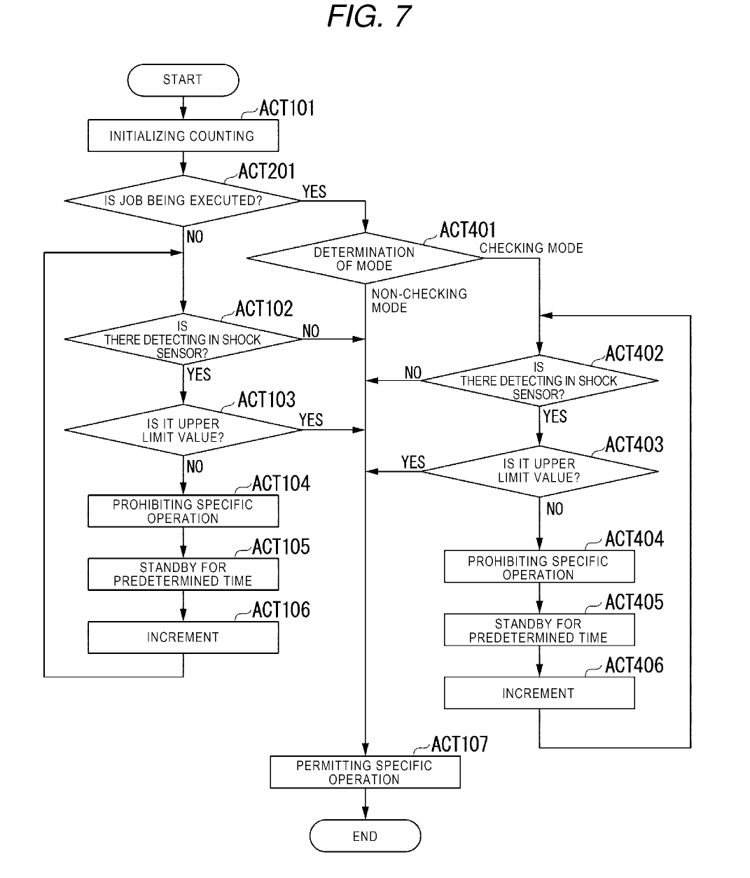

In addition, the image forming apparatus 100 may be configured so as to control permission or prohibition of a specific operation, including the fact whether or not it is a mode of checking the shock sensor 330 in the middle of executing a job. When being configured in this manner, the image forming apparatus 100 is configured so as to set a checking mode or a non-checking mode, as the mode. The mode of the image forming apparatus is set by a user in advance. The processing in this case will be described by using FIG. 7.

FIG. 7 is a flowchart which illustrates a flow of processing of another example of the image forming apparatus 100. The processing in FIG. 7 is executed at a predetermined timing. In addition, the same processing as that in FIG. 5 is attached with the same reference numeral as that in FIG. 5, in FIG. 7, and descriptions thereof will be omitted.

In the processing in ACT 201, when it is in the middle of executing a job (Yes in ACT 201), the determination unit 303 determines a mode of the image forming apparatus (ACT 401). Specifically, the determination unit 303 checks setting of the image forming apparatus, and determines whether a mode of the image forming apparatus is a checking mode or a non-checking mode. When the mode of the image forming apparatus is the non-checking mode (non-checking mode in ACT 401), the image forming apparatus 100 executes the processing in ACT 107.

On the other hand, when the mode of the image forming apparatus is the checking mode (checking mode in ACT 401), the determination unit 303 determines whether or not disturbance is detected (ACT 402). When disturbance is not detected by the shock sensor 330 (No in ACT 402), the image forming apparatus 100 executes the processing in ACT 107.

On the other hand, when disturbance is detected by the shock sensor 330 (Yes in ACT 402), the determination unit 303 determines whether or not the counter value is the upper limit value (ACT 403). When the counter value is the upper limit value (Yes in ACT 403), the image forming apparatus 100 executes the processing in ACT 107.

On the other hand, when the counter value is not the upper limit value (No in ACT 403), the determination unit 303 outputs a notification denoting that the counter value is not the upper limit value to the operation control unit 304. The operation control unit 304 prohibits a specific operation when obtaining the notification denoting that the counter value is not the upper limit value (ACT 404). Specifically, the operation control unit 304 does not execute the data writing operation and the unloading operation with respect to the HDD 320. Thereafter, the operation control unit 304 stands by for a predetermined time (ACT 405). The operation control unit 304 increments the counter value of the counter 350 after standby of a predetermined time (ACT 406). Thereafter, the image forming apparatus 100 executes processing in ACT 402 and thereafter.

In addition, the image forming apparatus 100 may be configured so as to control permission or prohibition of a specific operation according to a measured value which denotes intensity of disturbance which is detected in the shock sensor 330. When being configured in this manner, the determination unit 303 performs the following processing. The determination unit 303 determines whether or not the measured value included in the notification is the first threshold value or more, when disturbance is detected by the shock sensor 330. The first threshold value is a value in which disturbance is detected, or more, and a value of which an influence on the HDD 320 is assumed to be large. When the measured value included in the notification is not the first threshold value or more, the determination unit 303 determines whether or not the counter value is the upper limit value.

On the other hand, when the measured value included in the notification is the first threshold value or more, the determination unit 303 outputs a notification denoting that the measured value is the first threshold value or more to the operation control unit 304. That is, when the measured value included in the notification is the first threshold value or more, the determination unit 303 outputs a notification to the operation control unit 304, regardless of a value of the counter value. Thereafter, the operation control unit 304 prohibits a specific operation when obtaining the notification from the determination unit 303.

By being configured in this manner, when disturbance is large, the image forming apparatus 100 permits a specific operation even when the counter value does not reach the upper limit value. For example, when disturbance is large, there is a high possibility that the head may fall on the magnetic disc. Therefore, it is possible to move the head before the head falls on the magnetic disc, by being configured as described above. For this reason, it is possible to suppress a frequency of occurrence of a failure of the HDD 320.

According to at least any one of the above described embodiments, it is possible to suppress a frequency of occurrence of a failure of the HDD 320.

A part of functions of the image forming apparatus 100 in the above described embodiment may be executed in a computer. In such a case, a program for executing the function is recorded in a computer-readable recording medium. In addition, the program may be executed by causing the program recorded in the recording medium in which the above described program is recorded to be read by a computer system, and executing thereof.

Here, the “computer system” includes hardware such as an operating system, or a peripheral device. In addition, the “computer-readable recording medium” is a portable medium, a storage device, and the like. The portable medium is a flexible disk, a magneto-optical disc, a ROM, a CD-ROM, and the like. The storage device is a hard disk, or the like, which is built in the computer system. In addition, the “computer-readable recording medium” is a medium which dynamically holds a program for a short time, like a communication line in a case of transmitting a program through a communication channel. The communication channel is a network such as the Internet, a telephone line, or the like. In addition, the “computer-readable recording medium” may be a volatile memory in the computer system as a server or a client. The volatile memory is a memory which holds the program for a fixed time. The above described program may be a program for executing a part of the above described functions. In addition, the above described program may be a program which executes the above described function by being combined with the program which is recorded in the computer system in advance.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein maybe made without departing from the spirit of the inventions. The accompanying claims and their equivalents are intended to cover such forms or modifications as would fall within the scope and spirit of the invention.

1. An image forming apparatus comprising:
a sensor which detects disturbance;
an auxiliary storage device which is provided with a storage medium, and a head which performs operations of reading and writing of data with respect to the storage medium; and
a processor that executes instructions to perform operations, comprising:
performing a data writing operation with respect to the storage medium by controlling the head according to a command while the disturbance is not detected by the sensor;
determining not to perform a data writing operation with respect to the storage medium until a predetermined condition related to the disturbance is satisfied while the disturbance is detected by the sensor; and
performing the data writing operation with respect to the storage medium by controlling the head, when a predetermined condition related to the disturbance is satisfied while the disturbance is detected by the sensor.

2. The apparatus according to claim 1,
wherein the predetermined condition related to the disturbance is that the number of detection of the disturbance while the disturbance is detected is a predetermined value or more, and
wherein the operations further comprise:
executing a data writing operation with respect to the storage medium by controlling the head, when the number of detection of the disturbance while the disturbance is detected is the value or more.

3. The apparatus according to claim 1, wherein the operations further comprise:
executing an operation with respect to the storage medium, by controlling the head, when a job is being executed at a point of time in which the disturbance is detected by the sensor.

4. The apparatus according to claim 1, wherein the operations further comprise:
executing an operation with respect to the storage medium by controlling the head, when a failure does not occur in the image forming apparatus at a point of time in which the disturbance is detected by the sensor.

5. The apparatus according to claim 1, wherein the operations further comprise:
performing any one of data writing operation with respect to the storage medium and an operation of retreating the head from above the storage medium, when the predetermined condition related to the disturbance is satisfied.

6. The apparatus according to claim 1, wherein the operations further comprise:
controlling an operation with respect to the storage medium according to a measured value which denotes intensity of the disturbance which is detected by the sensor.

7. The apparatus according to claim 6, wherein the operations further comprise:
executing the data writing operation with respect to the storage medium by controlling the head, when the measured value is a first threshold value or more.

8. The apparatus according to claim 3, wherein the operations further comprise:
controlling an operation according to a detection result using the sensor, when a job is being executed, and a mode of the image forming apparatus is a mode in which the detection result using the sensor is confirmed, and executing the data writing operation with respect to the storage medium by controlling the head, when a job is being executed, and a mode of the image forming apparatus is a mode in which the detection result using the sensor is not confirmed.

9. The apparatus according to claim 1, wherein the operations further comprise:
determining not to execute the data writing operation with respect to the storage medium when the disturbance is detected by the sensor, and the predetermined condition is not satisfied.

10. An operation control method comprising:
performing a data writing operation with respect to a storage medium by controlling a head which performs operations of reading and writing of data with respect to the storage medium according to a command while a disturbance is not detected by a sensor;
determining not to execute the data writing operation with respect to the storage medium which is provided in an auxiliary storage device, until a predetermined condition related to the disturbance is satisfied while the disturbance is detected by the sensor; and
executing the data writing operation with respect to the storage medium by controlling the head when the predetermined condition related to the disturbance is satisfied, while the disturbance is detected by the sensor.
